(19) United States
(12) Patent Application Publication
(10) Pub. No.: US 2014/0060853 A1
(43) Pub. Date: Mar. 6, 2014

(54) MULTI-PURPOSE FLUID CONDUCTING SWIVEL ASSEMBLY

(71) Applicant: Premiere, Inc., New Iberia, LA (US)

(72) Inventors: Kris Henderson, Lafayette, LA (US); Lee M. Robichaux, Lafayette, LA (US)

(21) Appl. No.: 14/014,985

(22) Filed: Aug. 30, 2013

Related U.S. Application Data
(60) Provisional application No. 61/695,426, filed on Aug. 31, 2012.

(51) Int. Cl. E21B 34/10; F16L 27/08; F16L 17/02

(52) U.S. Cl. CPC E21B 34/10; F16L 17/02; F16L 27/0804
USPC 166/374; 285/98

(57) ABSTRACT

A fluid conducting swivel assembly permits selective transmission of control fluid under pressure through the swivel assembly, while reducing rotational friction and protecting the integrity of fluid pressure sealing elements of such swivel assembly during rotation. The fluid conducting swivel has sufficient strength to accommodate high axial loading and torque forces, while permitting high speed rotation.

### CROSS REFERENCES TO RELATED APPLICATION

PRIORITY OF U.S. PROVISIONAL PATENT APPLICATION Ser. No. 61/695,426, FILED Aug. 31, 2012, INCORPORATED HEREIN BY REFERENCE, IS HEREBY CLAIMED.

### STATEMENTS AS TO THE RIGHTS TO THE INVENTION MADE UNDER FEDERALLY SPONSORED RESEARCH AND DEVELOPMENT

NONE

### BACKGROUND OF THE INVENTION

1. Field of the Invention

The present invention pertains to a fluid-conducting swivel assembly that permits high speed rotation without damaging fluid pressure sealing elements. More particularly, the present invention pertains to a fluid conducting swivel assembly having high tensile strength that can support both high axial string loading, as well as substantial torque loading.

2. Brief Description of the Prior Art

Efficiency in connection with oil and gas operations, especially in terms of drilling rate, has been addressed with great earnest for many years. However, drilling rate is not the only variable affecting operational costs; pipe string assembly and installation rate, as well as other down hole well operations, generally have about the same cost-effect as drilling rate. The present invention addresses an increase in efficiency and efficacy of such operations (and a resulting decrease in costs associated with such operations) without sacrificing safety concerns.

During down hole operations in a well, casing, drill pipe and other tubular goods are typically inserted into a pre-drilled well bore in a number of separate sections of substantially equal length commonly referred to as “joints.” The joints, which generally include threaded connections on each end, are typically joined end-to-end at the earth's surface (typically from a drilling rig) in order to form a substantially continuous “string” of pipe that reaches downward into a well.

During a pipe installation process, additional sections of pipe are added to the upper end of the pipe string at the surface in order to increase the overall length of the pipe string and its penetration depth in a well bore. The addition of pipe sections at the surface is repeated until a desired length of pipe is inserted into the well. The rate of assembly and installation of tubular goods can amount to many hours of total work time which, in turn, equates to higher costs. As such, time reduction in pipe string assembly and installation operations can result in significant cost reduction.

Similarly, during the pipe removal or “pulling” process, sections of pipe are removed from the upper end of the pipe string at the surface in order to decrease the overall length of the pipe string in a well bore. The removal of pipe sections at the surface is repeated until a desired length of pipe has been removed from the well. The rate of removal of tubular goods from a well can amount to many hours of total work time which, in turn, equates to higher costs. As such, time reduction in pipe string removal operations can also result in significant cost savings.

In many instances, a swivel assembly is utilized as part of a rig's equipment configuration in order to facilitate pipe installation and/or removal operations; although placement can vary, in many cases a swivel assembly is installed below a rig's top drive unit to allow for remote powering of tools or equipment situated below said top drive unit. In this regard, a swivel assembly is generally used to supply control fluid (such as pressurized hydraulic or pneumatic fluid) through said swivel assembly in order to actuate tools or equipment situated below said swivel assembly, while permitting rotation of such tools or equipment below said swivel assembly. Such equipment can include, without limitation, an attached pipe string, which can be extremely heavy resulting in significant axial loading on said swivel assembly.

In order to accommodate such rotation, conventional swivel assemblies typically utilize fluid pressure sealing elements. However, a significant and persistent problem encountered with conventional swivel assemblies involves pressurization of such sealing elements within such swivel assembly, thereby creating frictional resistance to rotation. Such frictional resistance to rotation, often referred to as a “PV” factor, comprises a ratio of differential pressure to rotational speed; the higher the differential pressures across a pressure sealing element, the lower the safe limit of rotational speed. As such, frictional resistance limits the overall rotational speed of such fluid conducting swivel assemblies, thereby preventing full utilization of top drive rotational speeds. Such limitation can adversely affect drilling, pipe installation and removal, as well as other down hole operations.

Thus, there is a need for a fluid conducting swivel assembly that permits transmission of pressurized control fluid through said swivel, while protecting the integrity of fluid pressure sealing members. The fluid conducting swivel of the present invention should have sufficient strength to accommodate high axial loading and torque forces while permitting high speed rotation, all without jeopardizing the integrity of pressure sealing elements.

### SUMMARY OF THE PRESENT INVENTION

In the preferred embodiment, the fluid conducting swivel assembly of the present invention comprises an outer swivel body having a central through bore. A swivel hub member is rotatably disposed within the central bore of said outer swivel body. A central mandrel is connected to said swivel hub member, and can be equipped with a quick release pin-end threaded connection on one end (for example, for quick and efficient connection to a top drive quill) and a quick release box-end connection on the other end (for example, for quick and efficient connection to a casing running tool, cement head or other equipment).

Said outer swivel body has at least one channel extending through said outer swivel body, while said swivel hub member provides a base for bearings to be mounted and has at least one channel extending there through. Pressurized control fluid can be directed through said channels of swivel body member and swivel hub member to a swivel base member that serves as a fluid distribution sub; said swivel base member can include at least one valve element used to facilitate different functions below said swivel assembly.

In one embodiment, said at least one valve element could comprise a pilot operated check valve that would allow an actuator, or a plurality of actuators, to be functioned in one direction, locking said actuators in place until a signal is sent to release pressure. In another embodiment, the distribution sub of the present invention provides for use of at least one pressure limiting valve, whether or not in combination with at least one check valve, to provide a limited force from an actuator when it is functioned.

The swivel assembly of the present invention effectively eliminates a significant PV effect by allowing fluid pressure seals of said swivel assembly to be energized only when fluid pressure is required to perform a particular action. Once said action is completed, said fluid pressure seals can be de-energized, such that said seals do not contact said swivel hub, eliminating frictional contact between said seals and said central swivel hub. As a result of this reduction (or outright elimination) of a PV effect, said swivel assembly does not act as a limiting factor for rotation by a top drive unit or other equipment. By way of illustration, but not limitation, a top drive unit situated above said swivel assembly can rotate drill pipe or other equipment situated below said swivel assembly at full speed without limitation by frictional forces generated by said swivel assembly.

The swivel assembly of the present invention allows for valves that lock, reduce, and/or relieve fluid to be located on the rotating portion (i.e., downstream side) of said swivel fluid pressure sealing elements. Further, placing all functioning motor(s) or actuator(s) downstream of such swivel fluid pressure sealing elements, instead of before said sealing elements, it is possible to operate said motor(s) or actuator(s) using impulse power, and then allowing fluid pressure to be taken off swivel assembly seals after such operation has been fulfilled. Any dimensions set forth herein and in the attached drawings are illustrative only and are not intended to be, and should not be construed as, limiting in any way.

Equipment and/or drill stem elements that can be remotely operated can include, but are not limited to, rotary actuators used to open or close valves, cylinders used to set or release slips (such as in a casing running tool), and or powering actuators in a cementing head in order to release darts, balls, plugs and the like.

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed. Further, dimensions, materials and part names are provided for illustration purposes only and not limitation.

FIG. 1 depicts a side view of a fluid conducting swivel assembly of the present invention.

FIG. 2 depicts a side sectional view of a fluid conducting swivel assembly of the present invention.

FIG. 3 depicts a side sectional view of a swivel hub member and outer swivel body member of a fluid conducting swivel assembly of the present invention.

FIG. 3A depicts a detailed view of the highlighted area depicted in FIG. 3.

FIG. 4 depicts a side sectional view of a fluid conducting swivel assembly of the present invention installed in connection with a casing running tool.

FIG. 5 depicts a side sectional view of a fluid pressure sealing element of the swivel assembly of the present invention.

FIG. 5A depicts a detailed sectional side view of the highlighted area depicted in FIG. 5.

### DETAILED DESCRIPTION OF A PREFERRED EMBODIMENT OF THE INVENTION

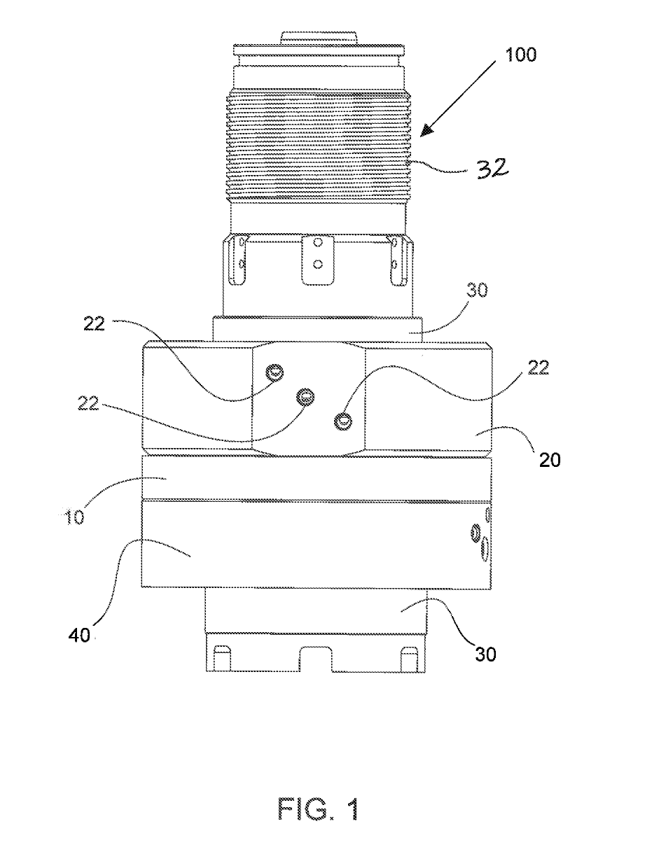

FIG. 1 depicts a side view of fluid conducting swivel assembly 100 of the present invention. In a preferred embodiment, fluid conducting swivel assembly 100 of the present invention comprises an outer swivel body member 20 having a central through bore. A swivel hub member 10 is rotatably disposed within said central bore of outer swivel body member 20. Central mandrel 30 is connected to said swivel hub member 10, as well as swivel base member 40. Said central mandrel 30 can be beneficially equipped with a quick release pin-end threaded connection 32 on one end (for example, for quick and efficient connection to a top drive quill) and a quick release box-end connection on the opposite end (for example, for quick and efficient connection to a casing running tool, cement head or other equipment). A plurality of ports 22 extend into outer swivel body member 10.

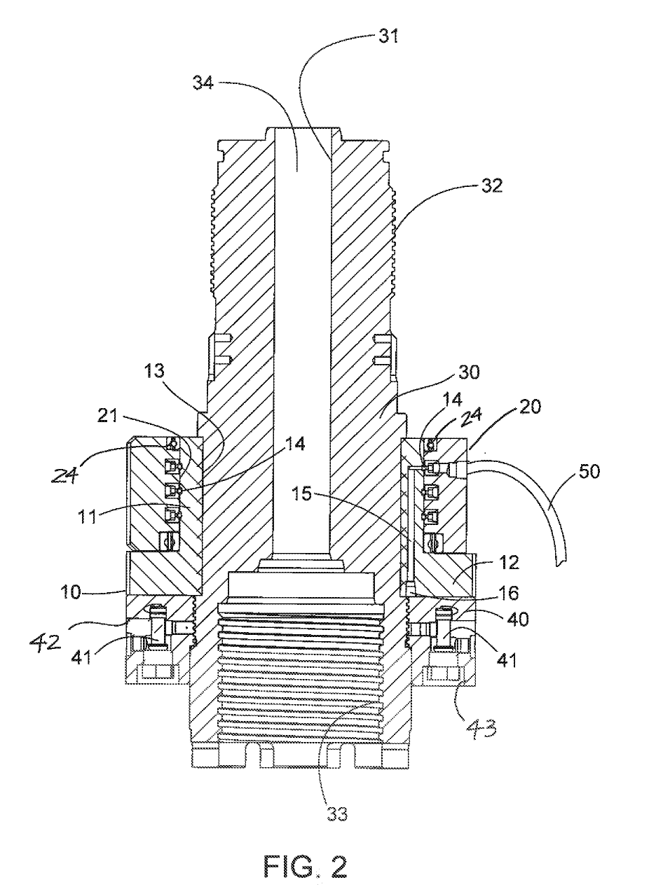

FIG. 2 depicts a side sectional view of fluid conducting swivel assembly 100 of the present invention. Swivel hub member 10 generally comprises substantially tubular sleeve member 11, as well as bottom ring section 12. A central through bore extends through said tubular sleeve member 11 and bottom ring section 12, and defines an inner surface 13.

In a preferred embodiment, swivel body member 20 has a central through bore that extends through said swivel body member 20 and defines bore inner surface 21. Swivel hub member 10 and, more particularly, upright tubular sleeve member 11 thereof, is rotatably disposed within said central through bore of said swivel body member 20.

Central mandrel 30 extends through the central through bore of swivel hub member 10, and is connected to swivel base member 40. Said central mandrel 30 has a central axially aligned through bore 34 defining bore inner surface 31. Said bore 34 can serve as a flow bore for well fluids (such as, for example, drilling mud or drilling fluids) to pass through fluid conducting swivel assembly 100. For example, fluids can be pumped through a top drive unit and pass through said bore 34 into equipment or pipe situated below fluid conducting swivel assembly 100, or vice versa.

Central mandrel 30 can be beneficially equipped with quick release pin-end (male) threaded connection 32 at its upper end to permit quick and efficient connection to a top drive quill, as well as quick release box-end (female) connection 33 at its bottom end to permit quick and efficient connection to a casing running tool, cement head or other equipment.

Swivel base member 40 provides a housing for valves 41. In a preferred embodiment, said valves 41 comprise pilot operated check valves that allow an actuator, or a plurality of actuators, to be functioned or operated as more fully described below. Said actuator(s) can be functioned in a single direction, effectively locking said actuator(s) in place until a subsequent signal is sent to again function or operate said actuator(s). In another embodiment, swivel base member 40 allows for use of at least one pressure limiting valve, whether or not in combination with at least one check valve, to provide a limited force from at least one actuator when said actuator is functioned.

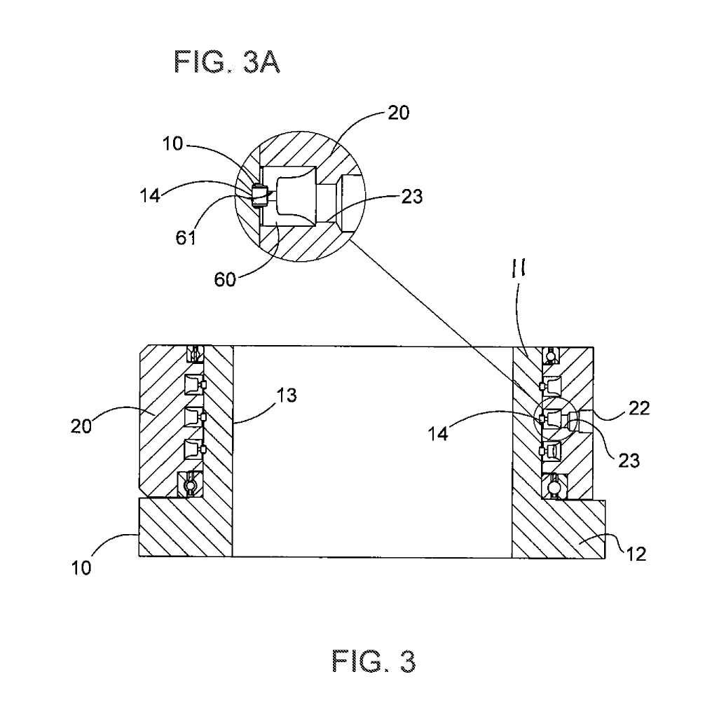

FIG. 3 depicts a side sectional view of swivel hub member 10 and outer swivel body member 20 of a fluid conducting swivel assembly 100 of the present invention, while FIG. 3A depicts a detailed view of the highlighted area depicted in FIG. 3. Swivel hub member 10 generally comprises substantially tubular and upright sleeve member 11, as well as bottom ring section 12. Swivel hub member 10 and, more particularly, tubular sleeve member 11 thereof, is rotatably disposed within said central through bore of said swivel body member 20. Central mandrel member 30 and swivel base member 40 are not shown in FIGS. 3 and 3A for clarity purposes.

Still referring to FIG. 3, each of said ports 22 provides an opening to a transverse channel or conduit 23 extending through said outer swivel body. Each conduit 23, in turn, extends until it is in fluid communication with an aligned recessed groove 14 extending around the outer circumference of tubular sleeve member 11 of swivel hub member 10. Although not shown in FIG. 3, each recessed groove is in fluid communication with a separate transverse conduit (such as conduit 23) extending through swivel body member 20 and opening at an outer port (such as ports 22 depicted in FIG. 1).

FIG. 3A depicts a detailed view of the highlighted area depicted in FIG. 3. Conduit 23 extends through swivel body 20 to fluid pressure sealing element 60 having port 61. Said conduit 23 is in fluid communication with an aligned and recessed groove 14 extending around the outer circumference of upright substantially tubular sleeve member 11 of swivel hub member 10. In this manner, fluid pressure seal element 60 is disposed between swivel body 20 and recessed groove 14 on tubular sleeve member 11.

When pressurized fluid is directed in a port 22 through conduit 23, fluid pressure sealing element 60 within said swivel assembly becomes energized and expands. (As used herein the term “pressurized” means a desired elevated pressure, which is typically greater than atmospheric or ambient pressure in the vicinity of said swivel assembly). When energized, said sealing element 60 contacts the outer surface of tubular sleeve member 11 thereby creating a fluid pressure seal between said swivel body member 20 and swivel hub member 10. However, such energized sealing element(s) 60 also create frictional resistance to rotation between said swivel body member 20 and swivel hub member 10; as noted above, the higher the differential pressures across fluid pressure sealing element 60, the lower the safe and effective limit of rotational speed between swivel body member 20 and swivel hub member 10.

Referring back to FIG. 2, a bore 15 extends from each recessed groove 14 through the body of swivel hub member 10, and terminates in an output port 16. Each of said output ports 16 is in fluid communication with an inlet port in swivel base member 40 leading to a valve 41. In a preferred embodiment, swivel base member 40 has side outlet port 42 and lower outlet port 43; such outlet ports provide alternate outlet orientation for hoses or lines from said swivel base member to actuators or other equipment situated below said swivel base member.

Fluid conducting swivel assembly 100 of the present invention permits communication of fluid from a control fluid supply/reservoir to fluid driven equipment used to power actuators, motors and/or other devices. As used herein, the term “fluid” is defined broadly to include any substance, such as a liquid or gas, that is capable of flowing and that changes its shape at a steady rate when acted upon by a force tending to change its shape.

Still referring to FIG. 2, hoses or other conduits 50 connect to ports 22. Control fluid can be pumped from an outside reservoir or source though hose 50, into port 22, through internal conduit 23 and port 61 of sealing element 60 disposed within swivel body member 20. Such fluid pressure energizes (deforms) fluid pressure sealing elements 60, creating a fluid pressure seal across any gap existing between said swivel body member 20 and swivel hub member 10, and directing such pressurized control fluid into recessed groove 14 in the outer surface of swivel hub member 10. It is to be observed that fluid conducting swivel assembly 100 of the present invention can operate pneumatically (wherein such control fluid is air or other gas); it is also possible that said swivel assembly can operate hydraulically (wherein such control fluid is hydraulic oil or other liquid).

Such control fluid passes from a recessed groove 14 through an internal channel 15 within swivel hub member 10, and is directed through a channel or flow conduit in swivel base member (not depicted in FIG. 2) to valve 41 disposed within said swivel base member 40. Said control fluid can pass through said valve 41, through a hose or other conduit, and into the inlet of a fluid driven cylinder or motor used to power actuators and/or other devices positioned downstream of said swivel assembly 100 in order to perform a desired operation downstream of said swivel. In this manner, said control fluid is permitted to pass through said swivel assembly 100 in order to function or operate device(s) situated downstream of said swivel assembly 100.

Once a particular action or operation has been performed as desired, said valve 41 can be closed, thereby isolating control fluid from said swivel assembly and trapping control fluid pressure downstream of said valve 41. Pressure can then be relieved from said swivel assembly 100; pressurized control fluid can then be bled off or released from swivel assembly 100 (typically through bleed-off valves 24) thereby allowing fluid pressure sealing elements 60 to de-energize or relax. Such fluid pressure sealing elements 60 can also be cooled by circulating flow of such control fluid. As a result, said fluid pressure sealing elements 60 of the swivel assembly 100 of the present invention are not exposed to elevated pressures during rotation of swivel assembly 100 of the present invention. Moreover, when relaxed said sealing elements 60 do not physically contact swivel hub 10, thereby allowing said swivel hub 10 to rotate within outer sleeve member 20 at higher speeds without generating frictional resistance or damaging said swivel sealing elements 60.

Fluid conducting swivel assembly 100 of the present invention permits transmission of control fluid under pressure through said swivel assembly 100, while protecting the integrity of fluid pressure sealing elements 60. Further, said fluid conducting swivel assembly of the present invention has sufficient strength to accommodate high axial loading and torque forces, while permitting high speed rotation without jeopardizing pressure sealing elements.

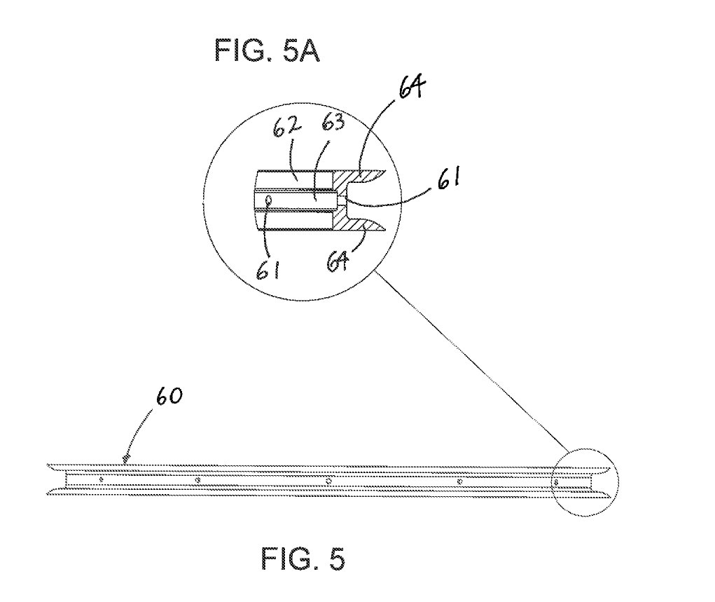

FIG. 5 depicts a side sectional view of a fluid pressure sealing element 60 of swivel assembly 100 of the present invention, while FIG. 5A depicts a detailed sectional view of the highlighted area depicted in FIG. 5. In a preferred embodiment, fluid pressure sealing element 60 comprises a ring-like body section (that can be disposed around tubular sleeve member 11 of swivel hub member 10 depicted in FIG. 3) defining a surface 62. Recessed fluid channel 63 extends around said fluid pressure sealing element 60, while spaced ports 61 extend through said fluid sealing element 60.

Fluid pressure sealing element 60 also has opposing seal extension members 64. Said fluid pressure sealing element 60 (including, without limitation, said seal extension member 64) can deform in response to fluid pressure. In a preferred embodiment, said fluid pressure sealing element 60 is at least partially constructed of elastomeric material, rubber, polymer and/or other sealing material exhibiting desired characteristics.

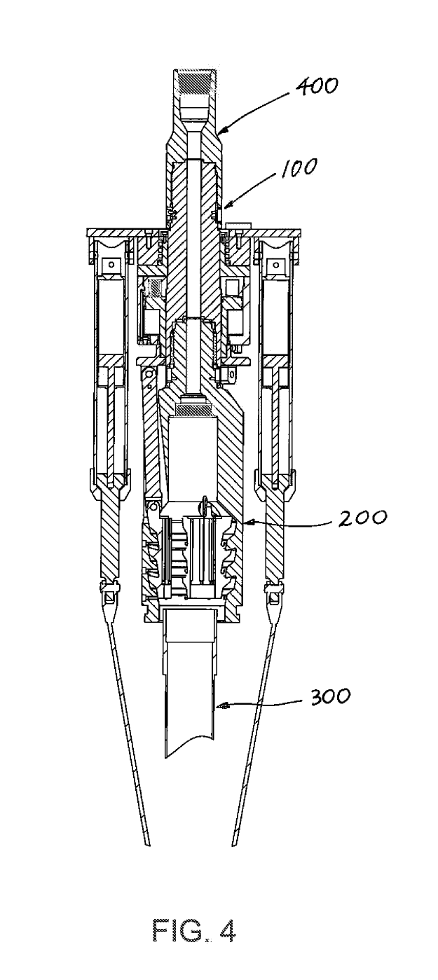

FIG. 4 depicts a side sectional view of a fluid conducting swivel assembly 100 of the present invention attached to a lower connection or quill of a top drive unit 400. Fluid conducting swivel assembly 100 is also attached to casing running tool assembly 200 which is used to grip and manipulate pipe joint 300 (such as, for example, a length of casing to be installed within a well). As discussed herein, swivel assembly 100 of the present invention effectively eliminates a significant PV effect by allowing fluid pressure sealing elements of said swivel assembly 100 to be energized and expanded only when pressurized control fluid is required to perform a particular action or operation (such as, for example, actuation of casing running tool assembly 200 in order to grip pipe joint 300).

Once a desired action completed, fluid pressure sealing elements of fluid power swivel assembly 100 can be selectively de-energized or relaxed, such that said sealing elements are not in physical contact with a swivel hub of fluid conducting swivel assembly 100, thereby eliminating frictional resistance to rotation caused by said sealing elements. As a result of this reduction (or outright elimination) of a PV effect, swivel assembly 100 does not act as a limiting factor for rotation by a top drive unit or other equipment. By way of illustration, but not limitation, a top drive unit 400 situated above said swivel assembly 100 can rotate pipe joint 300 or other equipment situated below said swivel assembly 100 at full speed without limitation by frictional forces generated by the seal members of said swivel assembly 100.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A fluid conducting swivel assembly comprising:
a) a swivel body having a central through bore and an outer surface, and at least one conduit extending from said outer surface to said through bore;
b) a swivel hub member having a central through bore, an outer surface, at least one channel disposed around said outer surface and a conduit extending from said channel to an outlet, wherein said swivel hub member is rotatably disposed within said central through bore of said swivel body and said at least one channel is aligned with said conduit of said swivel body;
c) at least one fluid pressure sealing element disposed between said swivel body and swivel hub; and
d) a check valve disposed downstream of said swivel hub outlet.

2. The fluid conducting swivel of claim 1, wherein said at least one fluid pressure sealing element comprises an elastomeric material.

3. The fluid conducting swivel of claim 1, wherein said at least one fluid pressure sealing element deforms when exposed to pressurized fluid.

4. The fluid conducting swivel of claim 3, wherein said expanded fluid pressure sealing element contacts said outer surface of said swivel hub.

5. The fluid conducting swivel of claim 1, wherein said at least one fluid pressure sealing element relaxes when not exposed to pressurized fluid.

6. The fluid conducting swivel of claim 5, wherein said relaxed fluid pressure sealing element does not contact said outer surface of said swivel hub.

7. A method for operating at least one remotely actuated device below a swivel assembly comprising:
a) pumping pressurized control fluid through a swivel assembly;
b) actuating said at least one device;
c) isolating control fluid downstream of said swivel assembly;
d) relieving control fluid pressure from said swivel assembly; and
e) rotating said swivel assembly.

8. The method of claim 7, wherein said swivel assembly further comprises:
a) a swivel body having a central through bore and an outer surface, and at least one conduit extending from said outer surface to said through bore;
b) a swivel hub member having a central through bore, an outer surface, at least one channel disposed around said outer surface and a conduit extending from said channel to an outlet, wherein said swivel hub member is rotatably disposed within said central through bore of said swivel body and said at least one channel is aligned with said conduit of said swivel body;
c) at least one fluid pressure sealing element disposed between said swivel body and swivel hub; and
d) a check valve disposed downstream of said swivel hub outlet;

9. The method of claim 8, wherein said at least one fluid pressure sealing element comprises an elastomeric material.

10. The method of claim 8, wherein said at least one fluid pressure sealing element deforms when exposed to pressurized control fluid.

11. The method of claim 10, wherein said fluid pressure sealing element contacts said outer surface of said swivel hub when deformed under pressure.

12. The method of claim 8, wherein said at least one fluid pressure sealing element relaxes when not exposed to pressurized fluid.

13. The method of claim 12, wherein said relaxed fluid pressure sealing element does not contact said outer surface of said swivel hub.

14. The method of claim 7, wherein said control fluid comprises air.

15. The method of claim 7, wherein said control fluid comprises hydraulic fluid.

16. A method for operating at least one remotely actuated device below a swivel assembly comprising:
a) pumping pressurized control fluid through a swivel assembly, said swivel assembly comprising:
(i) a swivel body having a central through bore, an outer surface and at least one conduit extending from said outer surface to said through bore;
(ii) a swivel hub member having a central through bore and a conduit extending through said swivel hub member and defining an outlet, wherein said swivel hub member is rotatably disposed within said central through bore of said swivel body and said conduit of said swivel hub member is in fluid communication with said conduit of said swivel body;
(iii) at least one fluid pressure sealing element disposed between said swivel body and swivel hub; and
(iv) a valve disposed downstream of said swivel hub outlet;
b) actuating said at least one device;
c) isolating control fluid pressure downstream of said swivel assembly;
d) relieving control fluid pressure from said swivel assembly; and
e) rotating said swivel hub member.

17. The method of claim 16, wherein said at least one fluid pressure sealing element comprises an elastomeric material.

18. The method of claim 16, wherein said at least one fluid pressure sealing element deforms when exposed to pressurized control fluid.

19. The method of claim 17, wherein said fluid pressure sealing element contacts said outer surface of said swivel hub when deformed under pressure.

20. The method of claim 8, wherein said at least one fluid pressure sealing element relaxes when not exposed to pressurized fluid, and said relaxed fluid pressure sealing element does not contact said outer surface of said swivel hub.
